(19) United States
(12) Patent Application Publication
(10) Pub. No.: US 2009/0027874 A1
(43) Pub. Date: Jan. 29, 2009

(54) ILLUMINATION DEVICE AND PORTABLE ELECTRONIC DEVICE INCORPORATING SAME

(75) Inventor: Jen-Tsorng Chang, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/142,154

(22) Filed: Jun. 19, 2008

(30) Foreign Application Priority Data
Jul. 26, 2007 (CN) 200710201186.7

(51) Int. Cl. H04M 1/22

(52) U.S. Cl. 362/88

(57) ABSTRACT

An illumination device includes a housing, an electrical connector, a light source and an elongated light guiding member. The electrical connector is disposed on the housing. The electrical connector has a first terminal contact for electrical connection to a power supply port of a portable electronic device, and a second terminal contact. The light source is electrically connected with the second terminal contact and configured for emitting light. The elongated light guiding member has a light incident surface at a distal end. The light incident surface faces the light source for receiving the light from the light source. The elongated light guiding member is configured for matingly contacting a peripheral side surface of the portable electronic device. The elongated light guiding member has a light emitting surface for emitting the light therefrom.

### BACKGROUND

1. Field of the Invention

The present invention relates to portable electronic devices and, particularly, to a portable electronic device incorporating an illumination device.

2. Description of Related Art

With the development of the technologies of wireless communication and information processing, portable electronic devices, such as mobile telephones and electronic notebooks, are now in widespread use. These electronic devices enable consumers to enjoy the convenience of high technology services, anytime and anywhere/at virtually any location (see “Specific Video Scenes Enlarged and Displayed on Mobile Phone Set”, IEEE Transactions on Consumer Electronics, Volume 53, Page 5˜10, February 2007).

At present, the portable electronic devices with a colorful appearance are very popular with young people. However, in a dark environment, e.g. at nighttime, the colorful appearance of the portable electronic devices is not clearly visible. Some portable electronic devices are coated with fluorescence substance to reinforce the brightness thereof. However, the brightness of the fluorescence substance is weak that the customer cannot be satisfied.

What is needed, therefore, is an illumination device and a portable electronic device having bright and colorful appearance.

### SUMMARY

In a present embodiment of the present invention, an illumination device for mounting on a portable electronic device includes a housing, an electrical connector, a light source and an elongated light guiding member. The portable electronic device includes a power supply port. The electrical connector is disposed on the housing. The electrical connector has a first terminal contact for electrical connection to the power supply port of the portable electronic device, and a second terminal contact. The light source is configured for emitting light. The light source is mounted in the housing. The light source is electrically connected with the second terminal contact. The elongated light guiding member is configured for transmitting the light from the light source therein. The elongated light guiding member has a light incident surface at a distal end. The light incident surface faces the light source for receiving the light from the light source. The elongated light guiding member is configured for matingly contacting a peripheral side surface of the portable electronic device. The elongated light guiding member has a light emitting surface for emitting the light therefrom.

Advantages and novel features will become more apparent from the following detailed description of the present illumination device and portable electronic device, when taken in conjunction with the accompanying drawings.

### BRIEF DESCRIPTION OF THE DRAWINGS

Many aspects of the present illumination device and portable electronic device can be better understood with reference to the following drawings. The components in the drawings are not necessarily drawn to scale, the emphasis instead being placed upon clearly illustrating the principles of the present illumination device and portable electronic device. Moreover, in the drawings, like reference numerals designate corresponding parts throughout the several views.

FIG. 1 is an exploded perspective view of a portable electronic device in accordance with a present embodiment.

FIG. 2 is a schematic, perspective view of the portable electronic device in FIG. 1.

FIG. 3 is a cross-sectional view taken along line III-III of FIG. 1.

### DETAILED DESCRIPTION OF THE PRESENT EMBODIMENT

Reference will now be made to the drawings to describe present embodiments of the illumination device and the portable electronic device incorporating the same.

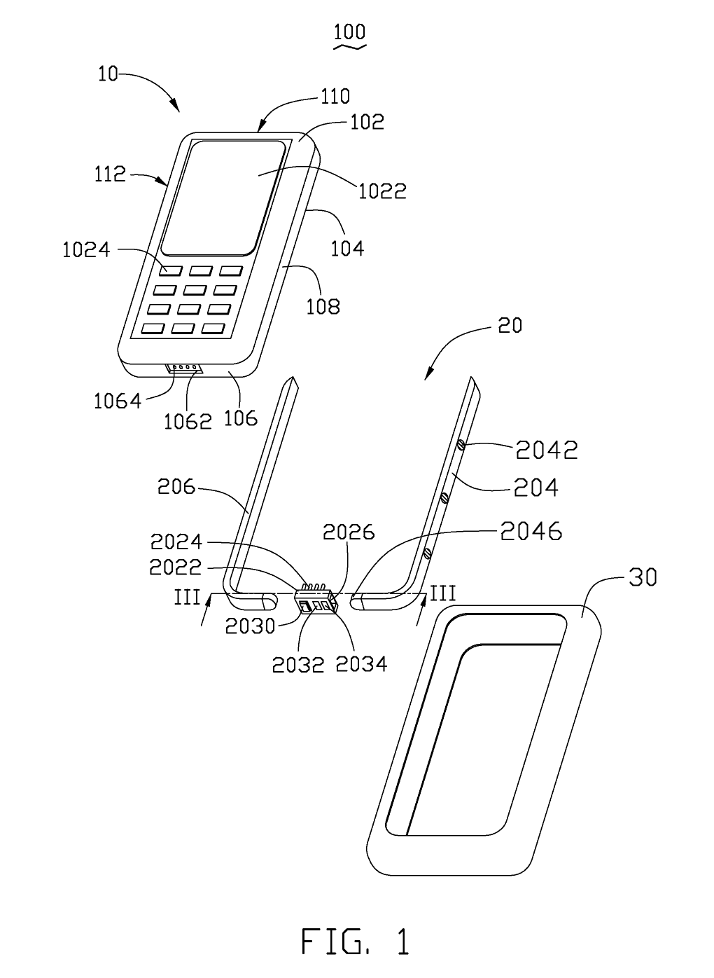

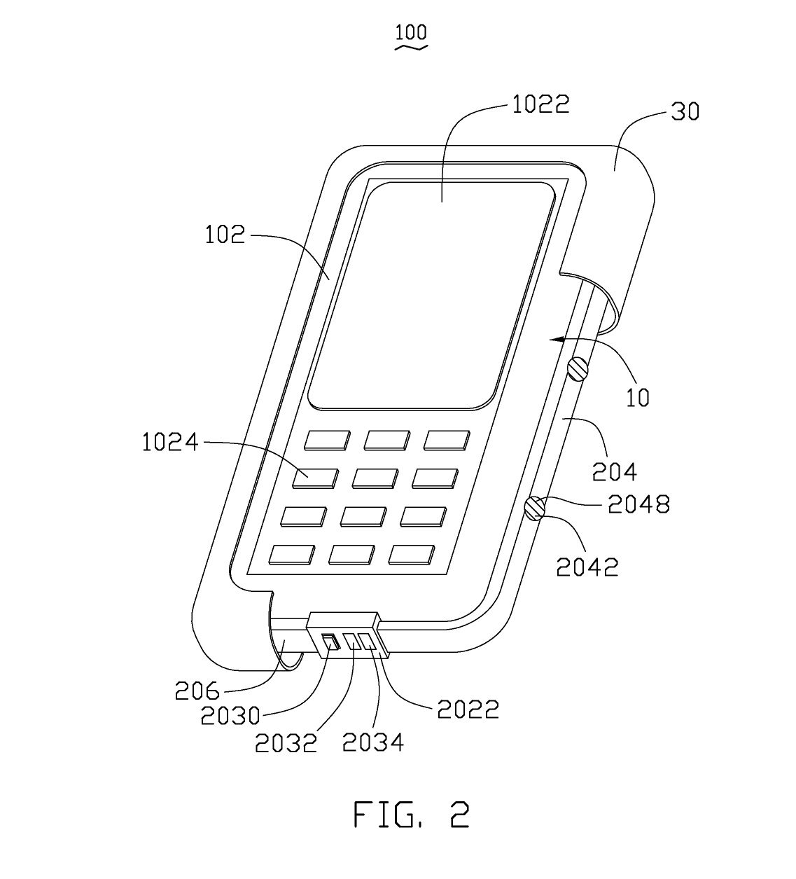

Referring to FIGS. 1 and 2, a portable electronic device is illustrated in accordance with an exemplary embodiment. In the exemplary embodiment, the portable electronic device is a mobile phone 100. The mobile phone 100 includes a main body 10, an illumination device 20 and a protective sheath 30.

The main body 10 has a front face 102, a back face 104 facing away from the front face 102, and four peripheral side surfaces 106, 108, 110 and 112. All of the four peripheral side surfaces 106, 108, 110 and 112 are adjacent to both of the front face 102 and the back face 104.

The front face 102 has a display 1022 at one end and a group of keys 1024 at the other end. The keys 1024 are used for inputting telephone numbers, writing text messages, etc.

The peripheral side surface 106 is parallel with the peripheral side surface 110, and the peripheral side surface 108 is parallel with the side surface 112. A power supply port 1062 is mounted in the peripheral side surface 106. The power supply port 1062 is configured for electrically connecting with a charging device (not shown), which is used for charging a battery received in the main body 10. The power supply port 1062 defines a plurality of plugholes 1064 therein. The plugholes 1064 are configured for being inserted by a connector (not shown) including a plurality of pins corresponding to the plugholes 1064.

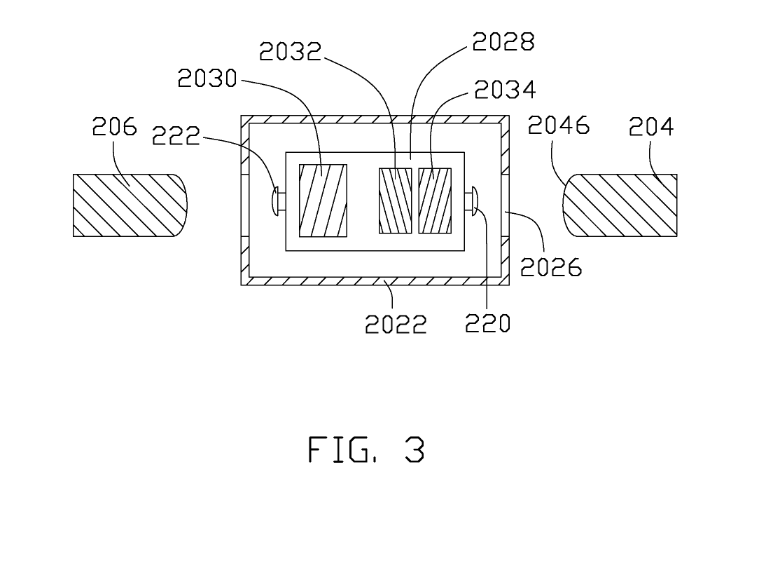

The illumination device 20 includes a housing 2022, an electrical connector 2024, a printed circuit board 2028 (in FIG. 3) and two elongated light guiding members 204 and 206. The printed circuit board 2028 is mounted in the housing 2022. Generally, the printed circuit board 2028 is a flexible printed circuit board. The printed circuit board 2028 is configured for electrically connecting the functional elements of the illumination device 20 and the main body 10 with each other.

The electrical connector 2024 includes a plurality of pins. The number of the pins equals to that of the plugholes 1064. Each of the pins of the electrical connector 2024 has a first terminal contact for inserting into the corresponding plughole 1064 for being electrically connected to the power supply port 1062 of the main body 10, and a second terminal. The second terminal of each pin of the electrical connector 2024 is electrically connected to the printed circuit board 2028. The electrical connector 2024 is mounted on the housing 2022.

Referring to FIG. 3, the illumination device 20 further includes two light sources 220 and 222, a switch button 2030, an illumination controlling module 2032, and a signal triggering chip 2034. The switch button 2030, the illumination controlling module 2032 and the signal triggering chip 2034 are mounted on the printed circuit board 2028, and can be electrically connected with the corresponding functional element/elements (not shown) by the printed circuit board 2028. The light sources 220 and 222 are both electrically connected with the printed circuit board 2028. In the exemplary embodiment, each of the light sources 220 and 222 includes a light emitting diode. The light sources 220 and 222 can emit light with same or different colors. It is to be understood that the number of the light sources can vary according to need.

The illumination controlling module 2032 is configured for controlling the light sources 220 and 222 to emit light in a predetermined manner, such as the light sources 220 and 222 emit light simultaneously or emit light alternatively with a predetermined frequency. The switch button 2030 is configured for controlling the signal triggering chip 2034 in on/off state. The signal triggering chip 2034 is electrically connected to the main body 10 by the printed circuit board 2028. The signal triggering chip 2034 is configured for receiving incoming signals of an incoming call, an incoming text message or other signals from the main body 10 via the power supply port 1062, and triggering the illumination controlling module 2032 to control the light sources 220 and 222 to emit light according to the above signals.

The elongated light guiding member 204 is identical with the elongated light guiding member 206. Here the elongated light guiding member 204 is taken as an example to be described in detail. The elongated light guiding member 204 is a tube that can transmit light to external environment. The elongated light guiding member 204 has a light incident surface 2046 at a distal end thereof. The housing 2022 defines a guiding hole 2026 therein. One distal end of the elongated light guiding member 204 inserts into the connector main body 2022 through the guiding hole 2026. Thus the elongated light guiding member 204 is receivingly engaged in the housing 2022. The light incident surface 2046 is positioned facing the light source 220 for receiving the light from the light source 220. In the exemplary embodiment, the light incident surface 2046 is a cylindrical surface. The elongated light guiding member 204 includes a number of light emitting surfaces 2042 on the outer surface thereof. The light emitting surface 2042 is a plane surface. A plurality of grooves 2048 is defined in the emitting surface 2042 to enhance the light uniformity of the light emitted from the light emitting surface 2042. The light emitted from light source 220 and transmitted in the elongated light guiding member 204 is reflected in the interior of the light tube 204 and then emits to the external environment through the light emitting surfaces 2042. The elongated light guiding member 204 bends at a right angle, so that the elongated light guiding member 204 can tightly contact with the peripheral side surfaces 106 and 108.

It is to be understood that a shape of the light emitting surface 2042 can also be a convex surface or a concave surface. In addition, the light incident surface 2046 can also be a plane surface.

Furthermore, the elongated light guiding member 204 can further extend or be shortened to contact with the peripheral side surface 110 or the peripheral side surface 106. A Shape of the cross-section of the elongated light guiding member 204 can be selected from the group consisting of circle, semicircle, ellipse and polygon.

In addition, the power supply port 1062 can also be a multi-pin port or a Universal Serial Bus (USB) port or other port types.

The protective sheath 30 is ring-shaped. A material of the protective sheath 30 can be selected from the group consisting of light-pervious plastic with flexibility or light-pervious, flexible rubber. The light-pervious plastic can be silica gel. The protective sheath 30 is configured for surrounding and contacting tightly with the four peripheral side surfaces 106, 108, 110 and 112, and the illumination device 20 to connect the illumination device 20 with the main body 10.

In use, the switch button 2030 can be pushed to turn on/off the illumination device 20. When the switch button 2030 is in an off state, the light sources 220 and 222 are triggered by the signal triggering chip 2034. The working principle of the illumination device 20 is described as below. When a signal, e.g. an incoming call signal, is received by the main body 10, the main body 10 transmits the signal to the signal triggering chip 2034 via the power supply port 1062 and electrical connector 202. Then the signal triggering chip 2034 triggers the illumination controlling chip 2032 to control the light sources 202 and 222 to flicker in a predetermined manner. The predetermined manner is determined by the types of signals. For example, when the signal is an incoming call signal, the predetermined manner may be simultaneous flickering of the light sources 202 and 222 in a given frequency. When the signal is an incoming text message signal, the predetermined manner may be alternative flickering of the light sources 202 and 222 in a given frequency. The light emitted from the light sources 202 and 222 is transmitted into the elongated light guiding members 204 and 206 respectively. Then the light emits out of the elongated light guiding members 204 and 206 from the light emitting surface 2042 and the light emitting surfaces defined in the light tube 206, respectively. When the signal is interrupted, such as the incoming call is answered, the light sources 202 and 222 stop illuminating.

When the switch button 2030 is in the on state, the light sources 202 and 222 will illuminate whether the main body 10 receives a signal.

According to the present embodiment, the portable electronic device 100 shows a bright and colorful characteristic which satisfies the users that enjoys fashionable products. Meanwhile, the illumination device 20 also can be used to illuminate the external environment.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. An illumination device for mounting on a portable electronic device, the portable electronic device comprising a power supply port, the illumination device comprising:
a housing;
an electrical connector disposed on the housing, the electrical connector having a first terminal contact for electrical connection to the power supply port of the portable electronic device, and a second terminal contact;
a light source for emitting light, the light source mounted in the housing, the light source being electrically connected with the second terminal contact;
an elongated light guiding member for transmitting the light from the light source therein, the elongated light guiding member having a light incident surface at a distal end, the light incident surface facing the light source for receiving the light from the light source, the elongated light guiding member being configured for matingly contacting a peripheral side surface of the portable electronic device, the elongated light guiding member having a light emitting surface for emitting the light therefrom.

2. The illumination device as claimed in claim 1, wherein the light source includes a light emitting diode.

3. The illumination device as claimed in claim 1, wherein a shape of a cross-section of the elongated light guiding member is selected from the group consisting of circle, semicircle, ellipse and polygon.

4. The illumination device as claimed in claim 1, further comprising an illumination controlling module for controlling flickering frequency of the light source.

5. The illumination device as claimed in claim 4, further comprising a signal triggering chip for receiving signals from the portable electronic device via the power supply port and triggering the illumination controlling module to operate.

6. The illumination device as claimed in claim 1, wherein the light emitting surface is a convex surface or a concave surface.

7. The illumination device as claimed in claim 6, wherein a plurality of grooves is defined in the light emitting surface.

8. The illumination device as claimed in claim 1, wherein the distal end of the elongated light guiding member is receivingly engaged in the housing.

9. A portable electronic device, comprising:
a main body;
a power supply port mounted on the main body;
a connector housing;
an electrical connector disposed on the connector housing, the electrical connector having a first terminal contact for electrical connection to the power supply port, and a second terminal contact;
a light source for emitting light, the light source mounted in the housing, the light source being electrically connected with the second terminal contact;
an elongated light guiding member for transmitting the light from the light source therein, the elongated light guiding member having a light incident surface at a distal end, the light incident surface facing the light source for receiving the light from the light source, the elongated light guiding member matingly contacting a peripheral side surface of the portable electronic device, the elongated light guiding member having a light emitting surface for emitting the light therefrom.

10. The portable electronic device as claimed in claim 9, wherein the light source includes a light emitting diode.

11. The portable electronic device as claimed in claim 9, wherein a shape of a cross-section of the elongated light guiding member is selected from the group consisting of circle, semicircle, ellipse and polygon.

12. The portable electronic device as claimed in claim 9, further comprising an illumination controlling module for controlling flicking frequency of the light source.

13. The portable electronic device as claimed in claim 12, further comprising a signal triggering chip for receiving signals from the portable electronic device via the power supply port and triggering the illumination controlling module to operate.

14. The portable electronic device as claimed in claim 9, wherein the light emitting surface is a convex surface or a concave surface.

15. The portable electronic device as claimed in claim 14, wherein a plurality of grooves is defined in the light emitting surface.

16. The portable electronic device as claimed in claim 9, wherein the distal end of the elongated light guiding member is receivingly engaged in the housing.
